(19) United States
(12) Patent Application Publication
(10) Pub. No.: US 2017/0322792 A1
(43) Pub. Date: Nov. 9, 2017

(54) UPDATING OF OPERATING SYSTEM IMAGES

(71) Applicant: Microsoft Technology Licensing, LLC, Redmond, WA (US)

(72) Inventors: David B. Rozee, Bellevue, WA (US); Patrick F. Maughan, Lynnwood, WA (US); Neil Gregory Huizenga, Woodinville, WA (US); Hiroaki Takamatsu, Redmond, WA (US); Tamas Sorosy, Redmond, WA (US); Ramesh Balasubramanian, Redmond, WA (US)

(21) Appl. No.: 15/146,768

(22) Filed: May 4, 2016

(51) Int. Cl. G06F 9/445; G06F 9/44

(52) U.S. Cl. CPC G06F 8/65; G06F 9/4406

(57) ABSTRACT

Embodiments disclosed herein are related to systems and methods for updating an operating system image. A system includes a processor and a system memory. A customization module receives end user defined customization parameters for an updatable base operating system image. The customization module further translates the received customization parameters into image state transition steps. The state transition steps cause the implementation of the customization parameters when applied to the updatable base operating system image. A generation module generates the updatable base operating system image by applying some of the image state transition steps. An update module updates the generated updatable base operating system image without the need for further end user input by applying some of the state transition steps to generate an updated operating system image.

### BACKGROUND

Operators of computing systems often prepare and save operating system images for their scenarios. The operating system images can then be used to execute those scenarios on various computing systems as needed. The operating system images, however, are static versions of the operating system and its related functionality such as applications and the like. Accordingly, the operating system images may be missing features or fixes anytime there is an update to the underlying operating system or related functionality.

The outdated operating system images can become a security risk as they may not include the most up to date fixes or patches. Or they may include outdated functionality. This often leads the operators of the computing system to have to manually update the operating system images, which can be time consuming and can consume a large amount of computing resources.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein are related to systems, methods, and computer readable medium for updating an operating system image. In one embodiment, a system includes a processor and a system memory. The system implements in the system memory a customization module that receives end user defined customization parameters for an updatable base operating system image. The customization module further translates the received customization parameters into image state transition steps. The state transition steps at least partially cause the implementation of the customization parameters when applied to the updatable base operating system image. The system also implements in the system memory a generation module that generates the updatable base operating system image by applying some of the image state transition steps. The system also implements in the system memory an update module that updates the generated updatable base operating system image based on a scheduled event without the need for further end user input by applying some of the state transition steps to generate an updated operating system image.

In another embodiment, end user defined customization parameters for an updatable base operating system image are received at a processor for an updatable base operating system image. The received customization parameters are translated into first image state transition steps and second image transition steps. The first and second image state transition steps at least partially cause the implementation of the customization parameters. The first image state transition steps are applied to generate the updatable base operating system image. The second image state transition steps are applied to update the generated updatable base operating system image. The updatable base operating system image is updated based on a scheduled event without the need for further end user input to generate an updated operating system image.

In an additional embodiment, updatable base operating system images are accessed. Image state transition steps are accessed that at least partially cause the implementation of end user defined customization parameters and cause the updating of the updatable base operating system images. The updatable base operating system images are updated by applying at least one of the image state transition steps.

Additional features and advantages will be set forth in the description, which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIGS. 2A and 2B illustrate an embodiment of a computing system that is able to update an operating system image;

FIG. 3A illustrates an embodiment of a conceptual view of an operating system image;

FIG. 3B illustrates an embodiment of a conceptual view of an updatable operating system image;

FIG. 3C illustrates an embodiment of a conceptual view of an updated operating system image;

FIG. 4 illustrates a flow chart of an example method for updating an operating system image; and

FIG. 5 illustrates a flow chart of an example method for updating an operating system image.

### DETAILED DESCRIPTION

Operating system images are widely used by computing system users to save their specific scenarios. The operating system images can then be repeatedly used to execute the specific scenarios on various computing systems as needed. The operating system images may be saved server setup configurations, images for a test machine farm, full hard-drive backup, images of turned off virtual machines, and cloud based virtual machines.

However, the operating system images are not-running versions of the operating system and related functionality such as applications and the like running on the operating system that can become quickly outdated as updates to the operating systems or the applications occur. Such outdated operating system images pose a security risk to the computing system as they may not include the most updated security patches. In addition, they may not run as efficiently as desired.

The computing system user is often left with no alternative but to update the operating system image manually every time an update is needed. This can be very time consuming and computing resource consuming if the operating system image has not been used for a period of time in which many updates have become available or if even a single update is quite large. In addition, the computing system user may lack the skills necessary to manually update the operating system image. Alternatively, even if the user does have the necessary skills, the manual update process is prone to error and may lead to overly bloated operating system images.

Aspects of the disclosed embodiments relate to systems and methods that provide for the updating of operating system images. In the disclosed embodiments, the user provides customization parameters that define at least some functionality that the user desires to include in an updatable base operating system image. These customization parameters are translated into image state transition steps, which may be declarative statements, which at least partially cause the implementation of the customization parameters when applied.

The image state transition steps are applied to an existing operating system image to generate an updatable base operating system image. The updatable base operating system image includes tools and the like that enable it to be updated. The image state transition steps are applied to the updatable base operating system image to generate an updated operating system image without the need for further user input beyond providing the customization parameters. This process can be repeated as often as needed when updates are available to applied to the updatable base operating system image.

There are various technical effects and benefits that can be achieved by implementing aspects of the disclosed embodiments. By way of example, the user does not need to spend a large amount of time and computing resources to manually update the operating system image. In addition, the user does not need to have the skills to manually update the operating system. Further, the technical effects related to the disclosed embodiments can also include improved user convenience and efficiency gains.

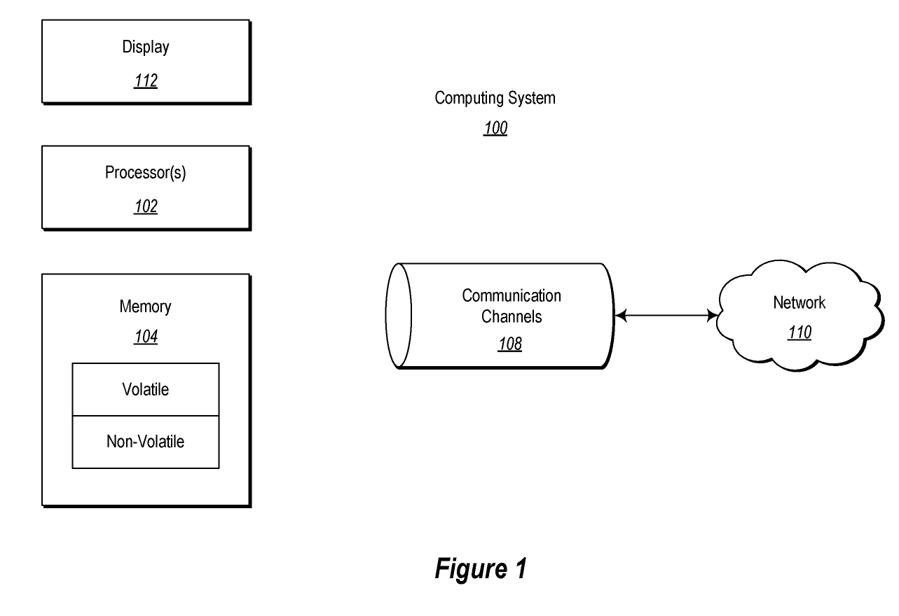

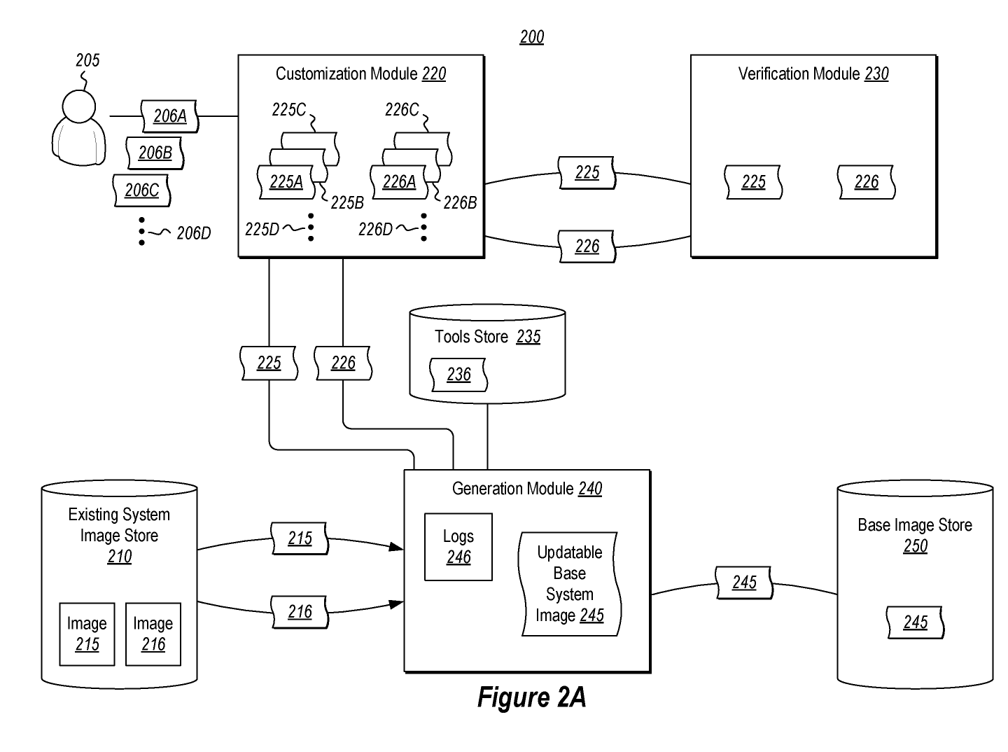

Some introductory discussion of a computing system will be described with respect to FIG. 1. Then, the performance of a computing system for the update of an operating system image will be described with respect to FIGS. 2A through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor to thereby provision the computing system for a special purpose. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads). With such objects and processes operating upon the computing system, the computing system is the equivalent of a special purpose computer that functions for the special purpose accomplished by the objects.

In the description that follows, embodiments are described with reference to acts that are performed by one or more computing systems. If such acts are implemented in software, one or more processors (of the associated computing system that performs the act) direct the operation of the computing system in response to having executed computer-executable instructions, thereby converting and configuring the computing system for a more specialized purpose than without such direction. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other computing systems over, for example, network 110. The computing system 100 also may include a display 112, which may be used to display visual representations to a user. Of course, the computing system need not include the display 112

Embodiments described herein may comprise or utilize a special purpose or general-purpose computing system including computer hardware, such as, for example, one or more processors and system memory, as discussed in greater detail below. Embodiments described herein also may include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When data is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses, watches, and so forth) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Attention is now given to FIGS. 2A and 2B, which illustrate an embodiment of a computing system 200, which may correspond to the computing system 100 previously described and which may be implemented on any number of physical and/or virtual computing systems. The computing system 200 includes various modules or functional blocks that may implement the various embodiments disclosed herein as will be explained. The various modules or functional blocks of computing system 200 may be implemented on a local computing system or may be implemented on a distributed computing system that includes elements resident in the cloud or that implement aspects of cloud computing. The various modules or functional blocks of the computing system 200 may be implemented as software, hardware, or a combination of software and hardware. The computing system 200 may include more or less than the modules illustrated in FIGS. 2A and 2B and some of the modules may be combined as circumstances warrant. Although not necessarily illustrated, the various modules of the computing system 200 may access and/or utilize a processor and memory, such as processor 102 and memory 104, as needed to perform their various functions. Accordingly, the exact structure of the computing system 200 is not to be considered limiting to the embodiments disclosed herein.

As shown in FIG. 2A, the computing system 200 may include an existing system image store 210. The existing image store 210 may be associated with an entity that owns or produces an operating system or the like and that stores an existing operating system image 215. Alternatively, the existing image store 210 may be associated with a particular end user 205 and may include an existing operating system image 216 that has been customized for the specific needs of the end user 205.

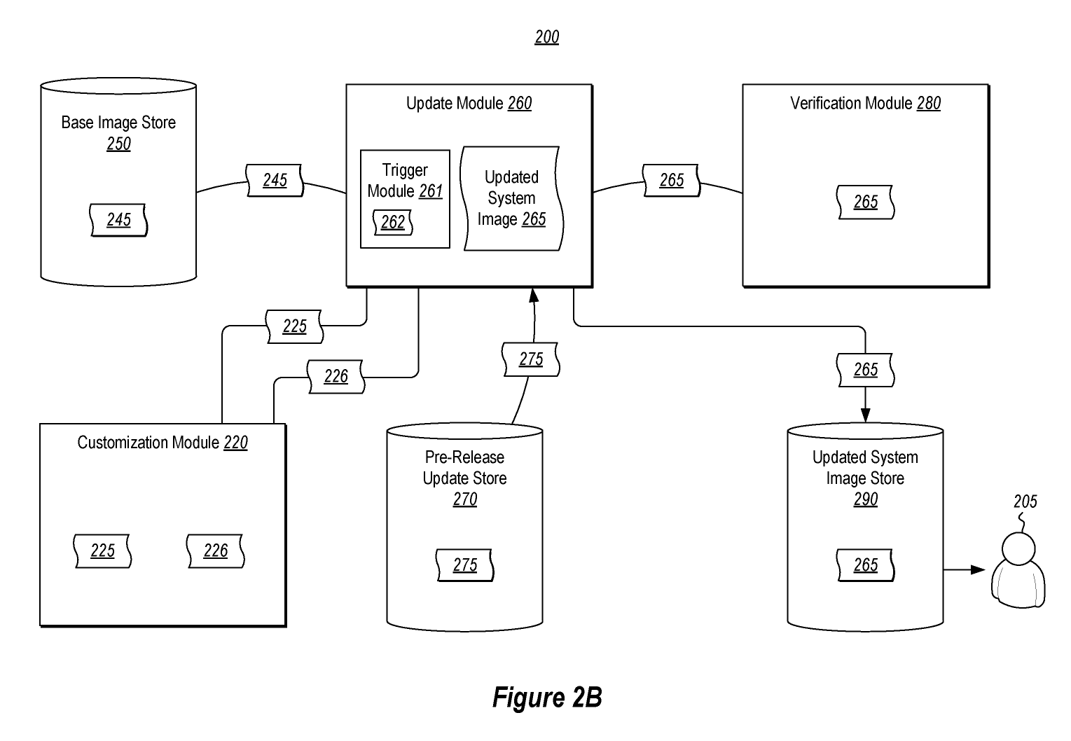

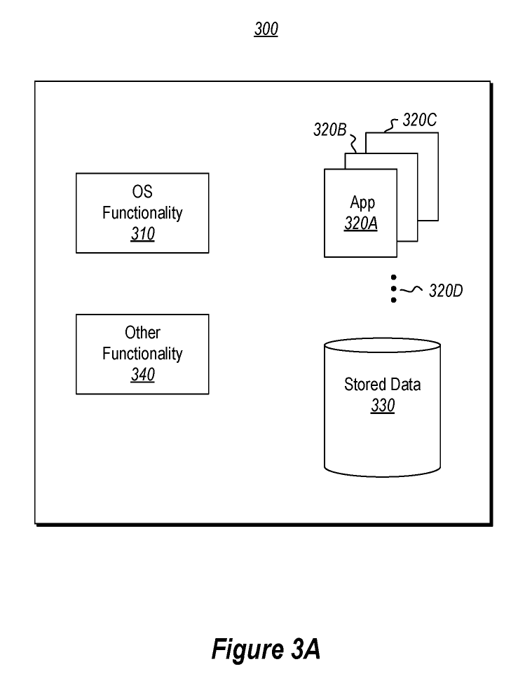

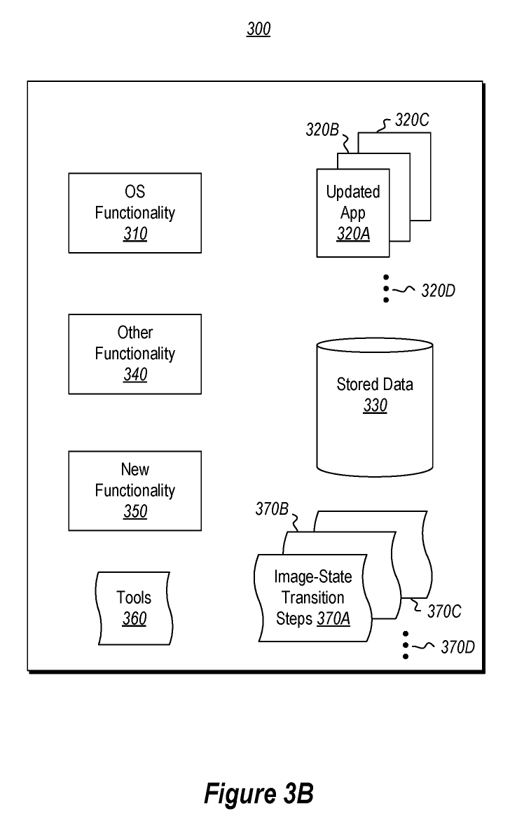

FIG. 3A illustrates an example of an operating system image 300 that may correspond to the existing operating system image 215 or 216. The operating system image 300 of FIG. 3 is intended to provide a conceptual view of an operating system image and some of the functionality it may include and is for helping to understand the embodiments disclosed herein. Accordingly, the elements or blocks shown in the figure are not to imply any actual structure or make-up of the operating system image. Accordingly, the actual functionality shown (or not shown) in the operating system image 300 of FIG. 3A (or of the conceptual views shown in FIGS. 3B and 3C) is not to be considered limiting of any of the operating system images disclosed herein.

In some embodiments, the operating system image 300 may be a disk image that includes a copy of a disk volume and its underlying files and file directories or that includes a portion of the disk volume. The disk image may include a sector-by-sector copy that may replicate the structure of a storage device such as a hard drive or the like. The operating system image may also be a virtual operating system image for one or more virtual machines resident on a single computing system or distributed in the cloud. The operating system image 300 may be mounted onto a computing system to restore the functionality of the operating system image 300 in a computing system where it is mounted.

As shown, the operating system image 300 may include operating system functionality 310, which represents the functionality of a common operating system. The underlying operating system of the operating system functionality 310 may be any reasonable operating system that controls a computing system, a distributed computing system, or a virtual computing system.

The operating system image 300 may also include applications 320A, 320B, and 320C, which collectively may be referred to herein as applications 320. The ellipses 320D represent that the operating system image 300 may include any number of additional applications 320. The applications 320 may be any applications that run on the computing system.

The operating system image 300 may also include stored data 330. The stored data 330 may be any data, data files, registries, or the like that are used by operating system and the applications of the operating system image 300. The stored data 330 may also be any data stored on the underlying computing system.

The operating system image may further include other functionality 340. The other functionality 340 may represent any additional functionality of the operating system image 300.

Returning to FIG. 2A, the computing system 200 may include a customization module 220. In operation, the customization module 220 may provide an interface or the like that the end user 205 may use to provide customization parameters 206A, 206B, 206C, or any number of additional customization parameters as illustrated by the ellipses 206D (hereinafter also simply referred to as “customization parameters 206”) for inclusion in an updatable base operating system image as will be explained in more detail to follow. The end user 205 may be one or more human users or may be a computing system or a form of artificial intelligence.

The customization parameters 206 may define at least some functionality that the end user 205 desires to include in the updatable base operating system image. The customization parameters 206 may specify functionality of the underlying operating system of the updatable base operating system image including specifying which portions of the operating system to implement and specifying end user 205 specific functionality to implement. The customization parameters 206 may also specify which portions of the operating system should be updated and which security patches should be applied. The customization parameters 206 may also specify which applications, including both applications from the owner or manufacturer of the operating systems and applications that are provided by third parties, should be included in the updatable base operating system image. The customization parameters 206 may also specify end user 205 registry settings, account settings, logon settings, passwords, and installation settings. Further the parameters may specify data, binaries, and the like that the end user 205 desires to be included in the updatable base operating system image. In one embodiment, the customization parameters 206 may specify how often the updatable base operating system image should be updated based on a scheduled event or trigger as will be explained in more detail to follow.

Accordingly, the customization parameters 206 may specify any reasonable functionality for the updatable base operating system image that is desired by the end user 206 and any particular type of customization parameters 206 implemented by the customization module 220 is not to be limiting of the embodiments disclosed herein. As will be appreciated after reading this specification, different types of end users 205 may require different functionality for an updatable base operating system image and the embodiments disclosed herein provide for customizing such functionality as needed.

The customization parameters 206 may be received by or otherwise accessed by the customization module 220. The customization module 220 may then translate at least some of the customization parameters 206 into first image state transition steps 225A, 225B, 225C, and any additional number of first image state transition steps as illustrated by ellipses 225D (hereinafter also referred to simply as “first image state transition steps 225”). The first image state transition steps 225 may at least partially cause the implementation of the various customization parameters 206 or at least cause the implementation of the underlying functionality of the customization parameters 206. For example, the image state transition steps may cause additions to the operating system image, modifications to the operating system image or removals from the operating system image.

In some embodiments the first image state transition steps 225 may be in the form of declarative statements of a declarative language that define different operating system image end results. For example, the first image state transition step 225A may be a declarative statement that is translated from a customization parameter that specifies, but is not limited to, one or more of an end user registry settings, account settings, logon settings, passwords, and unattended installation settings. The first image state transition step 225A may cause, when applied during the generation of the updatable base operating system image 245 and/or during an update of the updatable base operating system image 245, that the end user registry settings, account settings, logon settings, passwords, unattended installation settings, etc. are implemented in the updatable base operating system image 245 as will be described. In like manner, the other first image state transition steps 225B, 225C, and 225D may also cause the implementation of one or more customization parameters 206 during the generation and/or update of the updatable base operating system image. It will be noted that although the above discussed addition functionality, the image state transition steps 225 may also specify the removal of operating system image functionality or a combination of adding and removing functionality. That is, one or more of the image state transition steps 225 may specify that the functionality of the updatable base operating system image 245 be returned to the functionality of an earlier version of the updatable base operating system image 245. Accordingly, the embodiments disclosed herein are not limited by whether the image state transition steps specify the addition, removal, or a combination of addition and removal of operating system image functionality.

In some embodiments, the customization module 220 may also translate at least some of the customization parameters 206 into second image state transition steps (hereinafter also referred to simply as “second image state transition steps 226”) 226A, 226B, 226C, and any additional number of first image state transition steps as illustrated by ellipses 226D, which may also be in the form of declarative statements and may function in the manner described previously for the first image state transition steps 225. In such embodiments, the customization parameters 206 that are translated into the second image state transition steps 226 are typically different from those that are translated into the first image state transition steps 225. However, the second image state transition steps 226 may be based on the same customization parameters 206 as the first image state transition steps 225. Accordingly, the first and second image state transition steps may be the same.

The customization module 220 may identify or otherwise determine that the first image state transition steps 225 are to be applied only during the initial generation of the updatable base operating system image 245 and that the second image state transition steps 226 are to be applied every time the updatable base operating system image 245 is updated. However, the customization module 220 may also determine that both the first and second image state transition steps 225 and 226 are to be applied during generation of the updatable base operating system image and during every update cycle.

In one embodiment, the end user 205 may already have access to an existing system image, such as system image 216 that has been produced by or for the end user, which has a functionality that the end user 205 would like to copy or to add to. In such embodiment, the customization module 220 may be able to generate the first image state transition steps 225 and/or the second image state transition steps 226 based on examining the functionality of the system image 216. In other words, rather than receive the customization parameters 206 in the manner previously described, the customization parameters are specified by the existing system image and the first image state transition steps 225 and/or the second image state transition steps 226 are generated based on this functionality. In this way, the customization module 220 is able to generate the image state transition steps for end users 205 that may not be able to define the customization parameters 206 in the manner previously described.

In a similar embodiment, the end user 205 may have access to a first existing system image and a second existing system image that has been produced by or for the end user. The first and second existing system images may have different functionality that the end user desires to copy from one image to the other. For example, the end user may desire to transform the first existing system image into the second existing system image. In such cases, the customization module 220 may be able to generate the first image state transition steps 225 and/or the second image state transition steps 226 of the second existing system image by examining the functionality of the second existing system image. These may then be applied to the first existing system image in the manner that will be explained in detail to follow to transform the first existing system image into the second existing system image. The same process may be followed if the end user 205 desires to transform the second existing system image into the first existing system image.

In another embodiment, the customization module 220 may be communicatively connected to an outside source different from the end user 205 that provides customization parameters 206 and/or the image state transition steps for a specific functionality of an operating system image desired by the end user. For example, the end user 205 may desire a specific functionality for an application such as the applications 320 in an operating system image and the owner of the application 320 may provide image state transition steps for that functionality. In such case, the customization module 220 may be able to receive the state transition steps for that functionality, which may then be applied in the manner that will be explained in detail to follow. In this way, the end user 205 is able to utilize image state transition steps generated by third parties.

In some embodiments, the computing system 200 may include a validation module 230. In operation, the validation module 230 receives or otherwise accesses the first and/or second image state transition steps 225 and 226 from the customization module 220. The validation module 230 may then perform various operations that verify that the first and/or second image state transition steps 225 and 226 will cause the generation of a valid updatable base operating system image 245. The validation module 230 may perform any reasonable operation that is able to ensure that the first and/or second image state transition steps 225 and 226 will perform correctly and thus the exact operation of the validation module is not limiting on the embodiments disclosed herein. The validation module may then return the first and/or second image state transition steps 225 and 226 to the customization module 220.

The computing system may further include a generation module 240 that receives or otherwise accesses the validated first and/or second image state transition steps 225 and 226 from the customization module 220. The generation module 240 also receives or otherwise accesses the operating system image 215 and/or the operating system image 216 from the system image store 210.

In operation, the generation module 240 generates the updatable base operating system image 245 by applying at least those image state transition steps that were identified to be applied during the initial generation of the updatable base operating system image 245 to the operating system image 215 and/or 216. For example, as described previously the generation module 240 may apply the first image state transition steps 225 during the initial generation of the updatable base operating system image 245. In some embodiments, additional image state transition steps may also be applied to the operating system image 215 and/or 216.

In some embodiments, the generation module 240 applies those image state transition steps that were identified to be applied during the initial generation of the updatable base operating system image 245 in multiple iterations. For example, the generation module 240 may apply the image state transition steps 225 or a portion of the image state transition steps 225 during a first iteration that results in a valid updatable base operating system image 245. During second and further subsequent iterations, the generation module 240 may again apply the image state transition steps 225 or a different portion of the image state transition steps 225 to the updatable base operating system image 245. In other words, the image state transition steps 225 may be applied in n number of iterations, where n is equal to or greater than 1. In this way, a valid updatable base operating system image 245 may be generated completely in one iteration and then have additional functionality added or removed from it in the second and subsequent iterations. Alternatively, the updatable base operating system image 245 may require the second and subsequent iterations before becoming fully valid. In some embodiments, the application of the first image state transition steps 225 may result in no change to the functionality of the operating system image 215 and/or 216 or the first image state transition steps 225 are not applied. Accordingly, the embodiments disclosed herein are not limited by how many times or how often the image state transition steps are applied to generate the updatable base operating system image. In some embodiments, the generation module 240 may also have access to a tools store 235 that includes various tools 236 that may be applied to the operating system image 215 and/or 216 by the generation module to generate the updatable base operating system image 245. The tools 235 may include tools, scripts, data, executables or the like that enable the updatable base operating system image 245 to be updated.

The generation module 230 may also include a log storage 246 or otherwise have access to an external log storage. The log storage 246 may include searchable logs that are generated any time that a base operating system image such as updatable base operating system image 245 is generated and that include information about the structure and functionality of the generated updatable base operating system image. This allows the end user 205 and/or the operator of the computing system 200 to easily access this information as needed.

Attention is now given to FIG. 3B, which illustrates a conceptual view of the operating system image 300 after it has had the image state transition steps 225 and/or 226 applied to it by the generation module 240 to generate an updatable base operating system image such as updatable base operating system image 245. Accordingly, the illustration of FIG. 2B particularly corresponds to the updatable base operating system image 245. As illustrated, the updatable base operating system image 300 includes the elements 310-340 previously described. In the embodiment of FIG. 3B, however, the application of the image state transition steps, such as image state transition steps 225, during the generation of the updatable base operating system image may have caused changes to the operating system functionality 310, one or more of the applications 320, the stored data 330, or the other functionality 340 if such changes (i.e., addition, removal, or other changes of functionality) were specified by one or more of the customization parameters 206. In addition, FIG. 3B shows that application of the image state transition steps may cause the implementation in the updatable base operating system image of new functionality 350 that was specified by one or more of the customization parameters 206 that did not exist in the operating system images 215 and/or 216. This may include addition of, removal of, or other changes to one or more of user accounts, registry settings, auto-login settings, and unattended installation settings, etc.

FIG. 3B also shows that the updatable base operating system image 300 may include tools 360 that correspond to the tools 236. As discussed previously, the tools 360 may be any tools, data, scripts, executables, or the like that enable the operating system image 300 to be updated.

FIG. 3B further shows that in some embodiments the base system 300 includes image state transition steps (hereinafter referred to “image state transition steps 370”) 370A, 370B, 370C, and potentially any number of additional state transition steps as illustrated by the ellipses 370D. The image state transition steps 370 are to be applied during an update of the updatable base operating system image 300 as will be explained in more detail to follow. The image state transition steps 370 may correspond to image state transition steps 225 and/or 226 and may be considered second image state transition steps that are applied during the update. Although shown as being part of the updatable base operating system image 300, this is for ease of illustration only. As will be explained, in some embodiments the image state transition steps 370 may be supplied to an update module 260 at the time that the operating system image is updated.

Returning to FIG. 2A, the computing system 200 may include a base image store 250. The base image store may be under the control of the end user 205, it may be under the control of the operator of computing system 200, or it may be under the control of a third party. As illustrated, the base image store 250 receives or otherwise accesses the updatable base operating system image 245 from the generation module 240 and stores the image. The end user 205 may access the updatable base operating system image 245 from the base image store 250 as needed. Alternatively, as will be explained in more detail to follow, the updatable base system image 245 may remain the base image store so that it may be updated.

Attention is now given to FIG. 2B, which illustrates a continuation of the computing system 200. As shown, the computing system 200 includes an update module 260. In some embodiments, the update module 260 may be the same module as the customization module 220 and may be implemented as a service machine farm with a number of physical or virtual machines.

In operation, the update module 260 receives or otherwise accesses the updatable base operating system image 245 from the base image store 250. The update module 260 may then apply one or more of the state image transition steps 225 and/or 226 to the updatable base system image 245 to generate an updated operating system image 265. In some embodiments, the image state transition steps may be included in the updatable base operating system image 245, such as the image state transition steps 370 shown in FIG. 3B. In other embodiments, the update module may receive or otherwise access the state image transition steps 225 and/or 226 from the customization module 220 as shown in FIG. 2B or from some other image state transition step store that is not illustrated, but that is accessible by the update module 260. In still other embodiments, some image state transition steps may be included in the updatable base operating system image 245 while others are received or accessed from the customization module 220 or from the other image state transition step store. In the embodiment where image state transition steps 226 are second image state transition steps, then it is the second state transition steps 226 that are applied to the updatable base operating system image 245 by the update module 260 during the update process.

In some embodiments, the update module 260 may apply those image state transition steps that were identified to be applied during an update directly to the operating system images 215 or 216. This may occur in those embodiments where the image state transition steps 225 were not applied to the operating system images 215 or 216 or where the image state transition steps 225 specified no change to the functionality of the operating system images 215 or 216.

In some embodiments, the update module 260 applies those image state transition steps that were identified to be applied during the update of the updatable base operating system image 245 to generate the updated operating system image 265 in multiple iterations. For example, the update module 260 may apply the second image state transition steps 226 or a portion of the image state transition steps 226 during a first iteration that results in the updated operating system image 265. During second and further subsequent iterations, the update module 260 may again apply the image state transition steps 226 or a different portion of the image state transition steps 226 to the updated operating system image 265. In other words, the image state transition steps 226 may be applied in n number of iterations, where n is equal to or greater than 1. In this way, the updated operating system image 265 may be generated completely in one iteration and then have additional functionality added to or removed from it in the second and subsequent iterations. Alternatively, the updated operating system image 265 may require the second and subsequent iterations before being fully generated. Accordingly, the embodiments disclosed herein are not limited by how many times or how often the image state transition steps are applied to generate the updated operating system image.

As previously discussed, the update module 260 is able to update the updatable base operating system image 245 in response to a scheduled event without the need for further end user 205 input beyond the customization parameters 206. A trigger module 261 is able to determine a scheduled event 262 including, but not limited to, a pre-defined schedule or pre-defined trigger that specifies how often or when the updatable base operating system image 245 should be updated into the updated operating system image 265. In this way, the updatable base operating system image 245 is able to be repeatedly updated without any further user input. This achieves an advantageous technical result or effect of ensuring that that updated operating system image 265 is as up to date as possible when the end user 205 uses the updated operating system image 265.

In some embodiments, the scheduled event 262 may be a pre-defined schedule specified in one or more of the state transition steps 225 and/or 226. For example, the end user 205 may have various business and/or operational needs that require that the updatable base operating system image 245 be updated at specific times, after the passage of a specified amount of time, or after specific occurrences such as a large change in data storage in the end user's computing systems. In such cases, the end user 205 may specify this as a scheduled event 262 in one of the customization parameters 206, which will then be translated into an image state transition step as previously described. The update module 260 may then update the updatable base operating system image 245 into the updated operating system image 265 as specified by the scheduled event 262.

In other embodiments, the scheduled event 262 may be a pre-defined trigger based on updates, fixes, patches, or the like to one or more of the elements of the updatable base operating system image 245. For example, the pre-defined trigger may specify that any time updates, fixes or patches are released to the underlying operating system to update its functionality, its security settings, or like by the owner of the operating system, the updatable base operating system image 245 should be updated into the updated operating system image 265. Alternatively, the pre-defined trigger may specify that an update should occur only after certain types of updates, fixes, or patches to the underlying operating system or for a subset of the updates, fixes, or patches. In like manner, the pre-defined trigger may specify that the updatable base operating system image 245 should be updated into the updated operating system image 265 after any changes, fixes, patches, or updates to one or more of the applications 320, or to changes or updates to the stored data 330, the other functionality 340, or the new functionality 350.

In one embodiment, the update module 260 may have access to a pre-release update store 270. The pre-release update store allows the owner of the underlying operating system of the updatable base operating system image 245 to store pre-release updates, fixes, patches or like 275 that have not yet been publicly released in a normal course of business. The update module 260 may then be able to apply the pre-release updates 275 when updating the updatable base operating system image 245 into the updated operating system image 265. The pre-defined schedule or pre-defined trigger may specify that the update occur whenever a pre-release update 275 is available in the store 270 so that the pre-release update is part of the updated operating system image 265. This advantageously provides a way for the pre-release updates to be repeatedly tested by an end user 205 without the end user having to install the pre-release updates before the testing may begin.

Attention is now given to FIG. 3C, which illustrates a conceptual view of the operating system image 300 after it has been updated according to the embodiments disclosed herein. Accordingly, the conceptual view of FIG. 3C corresponds to updated operating system image 265. As with FIGS. 3A and 3B, the view of FIG. 3C is a conceptual view that is for helping to understand the embodiments disclosed herein. Accordingly, the elements or blocks shown in the figure are not to imply any actual structure or make-up of the updated operating system image.

As shown in FIG. 3C, the updated operating system image includes updated OS functionality 310A which represents an update to the OS functionality 310, updated applications 320A1, 320B1, 320C1, and 320D1 which represents an update to the applications 320, updated stored data 330A which represents an update to the stored data 330, updated other functionality 340A which represents an update to the other functionality 340, and updated new functionality 350A which represents an update to the new functionality 350. Although the FIG. 3C shows all of these elements as having been updated, in some embodiments only some of the elements may be updated by the update process.

FIG. 3C also shows pre-release updates 390, which may correspond to pre-release updates 275. This represents that in some embodiments, the pre-release updates will be applied to the updated operating system image, although the actual updates may be applied to other elements such as the operating system functionality 310 or one or more of the applications 320.

Returning to FIG. 2B, in some embodiments the computing system 200 may include a verification module 280, which may be the same as verification module 230. In operation, verification module 280 receives or otherwise accesses the updated operating system image 265. The verification module 280 may then perform various operations that verify that the updated operating system image 265 performs correctly. The validation module 280 may perform any reasonable operation that is able to ensure that the updated operating system image 265 will perform correctly.

The computing system 200 may include an updated system image store 290, which may be the same store as the base operating system image store 250 and which may correspond to a release module for the embodiments disclosed herein. The updated system image store 290 stores the updated operating system image 265 so that it may be accessed by or released to the end user 205. In some embodiments, the updated system image store 290 may include a standard release mechanism that is used to release the updated operating system image 265 to the end user 205.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

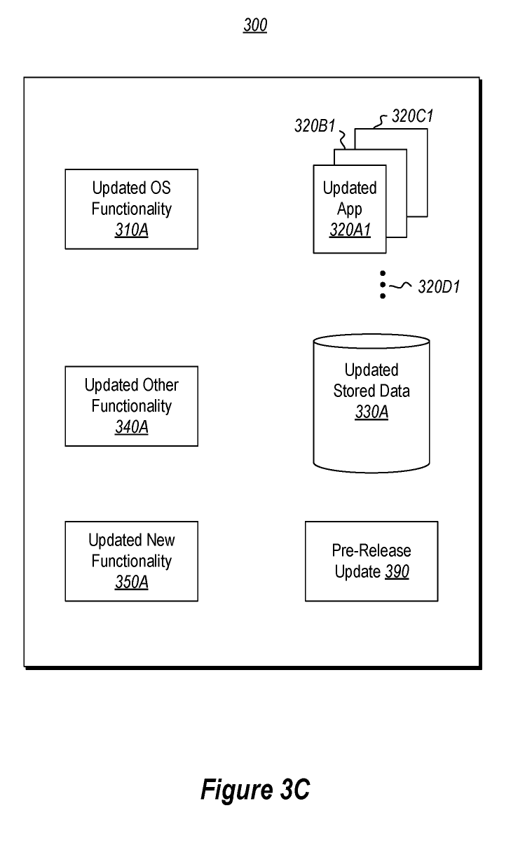

FIG. 4 illustrates a flow chart of an example method 400 for updating an operating system image. The method 400 will be described with respect to FIGS. 2A and 2B discussed previously.

The method 400 includes accessing one or more updatable base operating system images (act 410). For example, as previously discussed, the update module 260 may access the updatable base operating system image 245.

The method 400 includes accessing a plurality of image state transition steps that are configured to at least partially cause the implementation of end user defined customization parameters (act 420). For example, as previously discussed, the update module 260 may access the updatable base operating system image 245. As discussed, the updateable base operating system image 245 is generated at least in part by applying one or more of the first and/or second state transition steps 225 and 226. The first and second state transition steps 225 and 226 are configured to cause the implementation of the functionality defined by the customization parameters 206.

The method 400 includes updating the one or more updatable base operating system images by applying at least one of the plurality of image state transition steps (act 430). For example, as previously discussed, the update module 260 may apply one or more of the first and/or second state transition steps 225 and 226 to the updatable base operating system image 245 to generate the updated operating system image 265. As also discussed, application of the state transition steps occurs in response to a scheduled event. In some embodiments, the trigger module 261 may determine a scheduled event 262 that specifies how often or when the updatable base operating system image 245 should be updated into the updated operating system image 265.

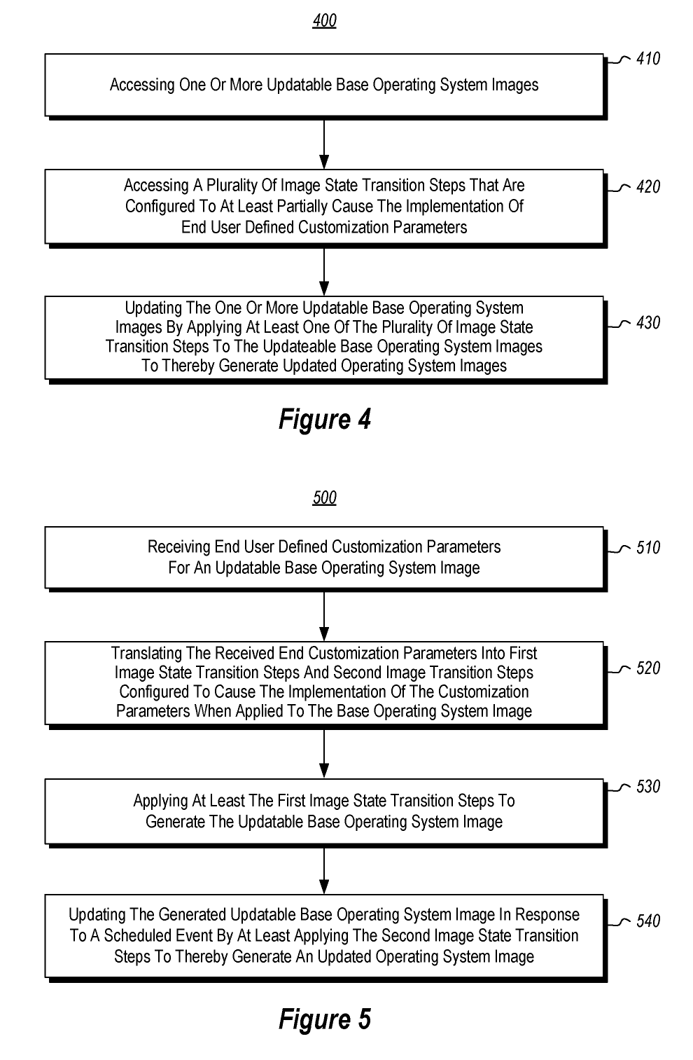

FIG. 5 illustrates a flow chart of an example method 500 for updating an operating system image. The method 500 will be described with respect to FIGS. 2A and 2B discussed previously.

The method 500 includes receiving end user defined customization parameters for an updatable base operating system image (act 510). For example, as previously described the customization module 220 receives the customization parameters 206 from the end user 205. The customization parameters 206 may define at least some functionality that the end user 205 desires to include in the updatable base operating system image.

The method 500 includes translating the received end customization parameters into first image state transition steps and second image transition steps (act 520). The first and second image state transition steps may be configured to cause the implementation of the customization parameters when applied to the base operating system image. For example, as previously discussed the customization module 220 may translate one or more of the customization parameters 206 into the image state transition steps 225 and 226.

The method 500 includes applying at least the first image state transition steps to generate the updatable base operating system image (act 530). For example, as previously discussed the generation module 240 may apply one or more of the first transition steps 225 to one of the operating system images 215 or 216 to generate the updatable base operating system image 245. This may be done in a multiple iterations as previously discussed.

The method 500 includes updating the generated updatable base operating system image in response to a scheduled event by at least applying the second image state transition steps (act 540). For example, as previously discussed the update module 260 may apply one or more of the second image state transition steps 226 to the updatable base operating system image 245 to generate the automatically updated operating system image 265. This may be done in a multiple iterations as previously discussed. In some embodiments, the trigger module 261 may determine a scheduled event 262 that specifies how often or when the updatable base operating system image 245 should be updated into the updated operating system image 265.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A system for automatically updating an operating system image, the system comprising:
a processor;
a system memory having stored thereon computer executable instructions that, when executed by the processor, implement:
a customization module configured to receive one or more end user defined customization parameters for an updatable base operating system image and configured to translate the received one or more customization parameters into one or more image state transition steps, the one or more image state transition steps being configured to at least partially cause the implementation of the customization parameters when applied to the updatable base operating system image;
a generation module configured to generate the updatable base operating system image by applying at least one of the one or more image state transition steps; and
an update module configured to update the generated updatable base operating system image one or more times in response to a scheduled event by applying at least one of the one or more image state transition steps to thereby generate an updated operating system image.

2. The system according to claim 1, wherein the scheduled event is a pre-defined schedule or a pre-defined trigger.

3. The system according to claim 1, wherein the executed computer executable instructions further implement:
a validation module configured to validate that the one or more image state transition steps will cause the implementation of the customization parameters or configured to validate that the updated operating system image is a valid operating system image.

4. The system according to claim 1, wherein the executed computer executable instructions further implement:
a release module configured to release the updated operating system image to the end user or to allow the end user to access the updated operating system image.

5. The system according to claim 1, further comprising:
a storage unit that stores the updatable base operating system image prior to the updatable base operating system image being updated by the update module.

6. The system according to claim 1, where the generated updatable base operating system image is generated to include one or more of tools, data, scripts, and executables that enable the update module to automatically update the updatable base operating system image.

7. The system according to claim 1, wherein the generated updatable base operating system image is based on one of a publicly available operating system image or an end user specific operating system image.

8. The system according to claim 1, wherein at least one of the one or more image state transition steps may be applied during the generation of the base operating system image and another one of the one or more image state transition steps is applied during each update cycle.

9. The system according to claim 1, wherein the one or more state transition steps includes one or more of registry settings, end user account settings, end user logon settings, and end user installation settings.

10. The system according to claim 1, wherein the one or more state transition steps cause one of the generation module or the update module to install operating system upgrades to the updatable base operating system image or updated operating system image that have not yet been publicly released.

11. A computer implemented method for updating, by a computing system, an operating system image, the method comprising:
an act of receiving, at a processor of the computing system, end user defined customization parameters for an updatable base operating system image;
an act of translating the received end customization parameters into first image state transition steps and second image transition steps, the first and second image state transition steps being configured to at least partially cause the implementation of the customization parameters;
an act of applying at least the first image state transition steps to generate the updatable base operating system image; and
an act of updating the generated updatable base operating system image in response to a scheduled event by at least applying the second image state transition steps to thereby generate an updated operating system image.

12. The method according to claim 11, wherein the fact of applying the first image state transition steps to generate the updateable base operating system image comprises applying the first image state transition steps in n number of iterations, where n is equal to or greater than 1

13. The method according to claim 11, wherein the act of applying the second image state transition steps to generate the updated operating system image comprises applying the second image state transition steps in n number of iterations, where n is equal to or greater than 1.

14. The method according to claim 11, wherein the act of applying the first image state transition steps results in no change to the functionality of an underlying operating system image or wherein the first image state transition steps are not applied.

15. The method according to claim 11, wherein the act of applying the first image state transition steps or the second image state transition steps returns the updatable base operating system image or the updated operating system image to a prior functionality.

16. The method according to claim 11, wherein the customization parameters are specified by a functionality of an existing operating system image and the first and/or second image state transition steps are generated based on that functionality.

17. The method according to claim 11, wherein the first and/or second image state transition steps are received from a party other than the end user.

18. The method according to claim 11, wherein the second image state transition steps are also applied during the generation of the updatable base operating system image.

19. The method according to claim 11, wherein the generated updatable base operating system image is based on a publicly available operating system image or based on an end user specific operating system image.

20. A computer program product comprising one or more computer-readable media having thereon computer-executable instructions that are structured such that, when executed by one or more processors of a computing system, configure the computing system to perform a method for updating an operating system image, the method comprising:
accessing one or more updatable base operating system images;
accessing a plurality of image state transition steps that are configured to at least partially cause the implementation of end user defined customization parameters; and
updating the one or more updatable base operating system images by applying at least one of the plurality of image state transition steps to the updateable base operating system images to thereby generate updated operating system images.
